(19) United States
(12) Patent Application Publication
(10) Pub. No.: US 2004/0113977 A1
(43) Pub. Date: Jun. 17, 2004

(54) Recording apparatus

(76) Inventors: Takahiro Esaki, Fukuoka-shi (JP); Kazunari Chikanawa, Tamana-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/730,983

(22) Filed: Dec. 10, 2003

(30) Foreign Application Priority Data
Dec. 11, 2002 (JP) P.2002-359050

(51) Int. Cl. B41J 2/155

(52) U.S. Cl. 347/42

(57) ABSTRACT

A recording apparatus provided with a plurality of print line heads 1 for respective colors and thereby performing color printing, in which at least a few of head lines 1 are placed by being offset in the Y direction perpendicular to the X direction which is a relative transportation direction of a recording medium 5.

### CROSS REFERENCE TO RELATED APPLICATION

This application is based upon and claims the benefit of priority of Japanese Patent Application No. 2002-359050 filed on Dec. 11, 2002, the contents of which are incorporated herein by reference in its entirety.

### BACKGROUND OF THE INVENTION

The present invention relates to a recording apparatus provided with a plurality of print line heads for respective colors and thereby performing color printing.

Conventionally, a color laser printer (CLBP) and a color ink jet printer (CIJP) of a serial printing method have been used as a color output apparatus for a personal computer (PC). Above all, the CIJP has been increasingly becoming popular in recent years due to its capability of printing a picture-quality image and its low cost. However, the CIJP is far inferior to the CLBP in terms of a printing speed.

Thus, a type that improved a printing speed with the use of a line head is now becoming available, though few in number. Under the present situation, however, the use of such a type is limited to a specific purpose, such as printing of business cards or printing of post cards. One of the reasons imposing this limitation is that it is difficult to manufacture a line head per se having a length equal to the width of A-4 size paper or the like.

In order to solve the difficulties, there has been proposed an idea of forming a line head by disposing a plurality of individual heads in a direction (Y direction) perpendicular to a relative transportation direction (X direction) of a recording medium for printing.

When a line head is formed by aligning a plurality of individual heads, it is needless to say that an accuracy in placement of the individual heads is crucial. The individual heads are aligned with a position accuracy of some micrometers in both the X and Y directions and an angle accuracy of 1/100 degree or less.

FIG. 8 is a characteristic view showing one example of a relation between a nozzle position and a discharge quantity of ink droplets in the individual head.

As can be understood from this drawing, a discharge quantity is stable at the center of the individual head, but a discharge quantity of ink droplets decreases at the both ends thereof due to irregularities during the fabrication sequence of the individual head, etc. In short, it is general that the individual head has irregularities in a discharge quality.

FIG. 9 is a characteristic view showing a discharge quantity of ink droplets from the entire line head formed by aligning a plurality of individual heads having irregularities in a discharge quality as described above.

As is shown in the drawing, the aforementioned characteristic of the individual head appears repetitively in a width cycle of the individual head.

FIG. 10 is a view used to explain an output result when a solid, uniform half-tone image is printed on a recording medium using the line head of FIG. 6 comprising the individual heads described above. As shown in the drawing, irregularities in the discharge quantity appear as density-varying streaks.

Of the printing-related characteristics of the head, a discharge quantity of ink droplets has been described. It should be appreciated, however, that the head often shows a characteristic such that a discharge direction of ink droplets is also stable at the center and unstable at the both ends of the individual head. Hence, at the joint portion of adjacent individual heads, dots formed on a recording medium from ink droplets are superimposed and an unwanted black streak may be produced, or dots are spaced apart and an unwanted white streak may be produced. Defects on an image, such as black streaks, white streaks, and density-varying streaks, are indicated by broken lines as shown in FIG. 11 for ease of explanation.

Next, FIG. 12 shows a schematic configuration when four line heads having the characteristic causing defects on an image as shown in FIG. 11 are aligned in the X direction for 4-color printing.

Referring to FIG. 12, a line head for yellow 1-Y, a line head for cyan 1-C, a line head for magenta 1-M, and a line head for black 1-K, each of which extends in the Y direction, are placed in the X direction.

It goes without saying that a position accuracy of the line heads for respective colors is crucial as is the position accuracy of the individual heads in a single line head. Hence, for a conventional recording apparatus, an arrangement for performing highly accurate alignment with respect to the X direction, the Y direction and an angle, and a technique for correcting displacement are proposed, for example, in JP-A-62-290567/(1987) and JP-A-10-44474/(1998). These arrangement and technique forcedly correct the positions of a plurality of line heads to the extent that the line heads can be deemed as being placed in equivalently the same positional relation.

When color printing is performed by aligning a plurality of line heads for respective colors in the X direction as described above, the characteristics of the line heads for respective colors are enhanced separately, which impairs an image quality considerably.

FIG. 13 shows appearances of a printing result on a recording medium in this instance. It should be noted that defects on an image, such as black streaks, white streaks, and density-varying streaks, are actually enhanced and produced in the same position; however, a degree of defects is indicated by the number of broken lines because it is difficult to illustrate variations correctly in the drawing.

### SUMMARY OF THE INVENTION

It is therefore an object of the invention to provide a recording apparatus provided with a plurality of print line heads for respective colors and thereby performing color printing, and capable of ensuring a print quality without the need to increase an accuracy of components or add complicated processing.

In order to achieve the above and other objects, a recording apparatus of the invention includes: a first line head from which ink of a first color is discharged; a second line head from which ink of a second color is discharged; and relative movement means for moving a recording medium relative to the first and second line heads, wherein the first line head is placed by being offset with respect to the second line head in a Y direction perpendicular to an X direction which is a relative transportation direction of the recording medium.

Consequently, even when the line heads for respective colors produce defects on an image, such as black streaks, white streaks, and density-varying streaks, these defects can be reduced by outputting the respective colors to be superimposed. It is thus possible to ensure the print quality without the need to improve an accuracy of components or add any complicated processing.

### BRIEF DESCRIPTION OF THE DRAWINGS

FIG. 1 is a block diagram showing an example of a schematic configuration of a system of a recording apparatus according to one embodiment of the invention.

FIG. 2 is a view schematically showing a relative positional relation between line heads for respective colors and a recording medium according to one embodiment of the invention.

FIGS. 3(a) to 3(d) are views schematically showing a relative positional relation between line heads for respective colors and a recording medium with the proceeding of a recording operation according to one embodiment of the invention.

FIG. 4 is a schematic view showing an enlarged portion of FIG. 2 to provide better understanding of an offset situation of the line heads in the Y direction according to one embodiment of the invention.

FIG. 5 is a schematic view showing appearances of a printing result on a recording medium when the line heads are offset according to one embodiment of the invention.

FIG. 6 is a schematic view showing a line head for use in a CIJP formed by providing a plurality of individual heads in the Y direction.

FIG. 7 is a schematic view showing an individual head in the line head of FIG. 6.

FIG. 8 is a characteristic view showing one example of a relation between a nozzle position and a discharge quantity of ink droplets in the individual head.

FIG. 9 is a characteristic view showing a discharge quantity of ink droplets from the entire line head formed by aligning a plurality of individual heads.

FIG. 10 is a view used to explain an output result when a solid, uniform half-tone image is printed on a recording medium using the line head of FIG. 6.

FIG. 11 is a schematic view showing a printing result on a recording medium using the line head of FIG. 6.

FIG. 12 is a schematic view showing a configuration for 4-color printing by aligning four line heads of FIG. 6 in the X direction.

FIG. 13 is a schematic view showing a result of 4-color printing on a recording medium when four line heads of FIG. 6 are aligned in the X direction.

### DETAILED DESCRIPTION OF THE PREFERRED EMBODIMENTS

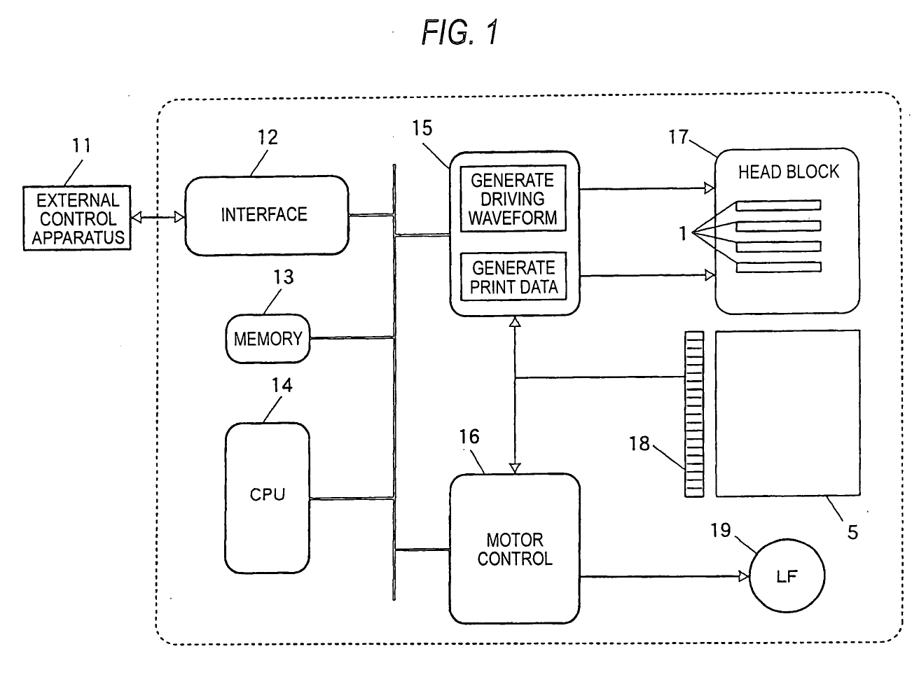

One embodiment of the invention will now be described with reference to FIG. 1 through FIG. 5. Similar members are labeled with the same reference numerals in these drawings, and an explanation for these members will not be repeated.

Referring to FIG. 1, a recording apparatus connected to an external control apparatus 11, such as a PC, includes: an interface portion 12 to send/receive image data and control commands of various kinds to/from the control apparatus 11; a memory 13 to store image data and control programs; a CPU 14 to control the entire recording apparatus; a head control portion 15 to generate print data and a driving waveform for driving a piezoelectric head and supply the same to a head block 17 comprising a plurality of line heads 1; a motor control portion 16 to drive an LF motor 19 used to transport a recording medium 5; and an encoder sensor 18 to generate a pulse used as the control reference for the motor control portion 16 and the head control portion 15, by detecting a transported position of the recording medium 5.

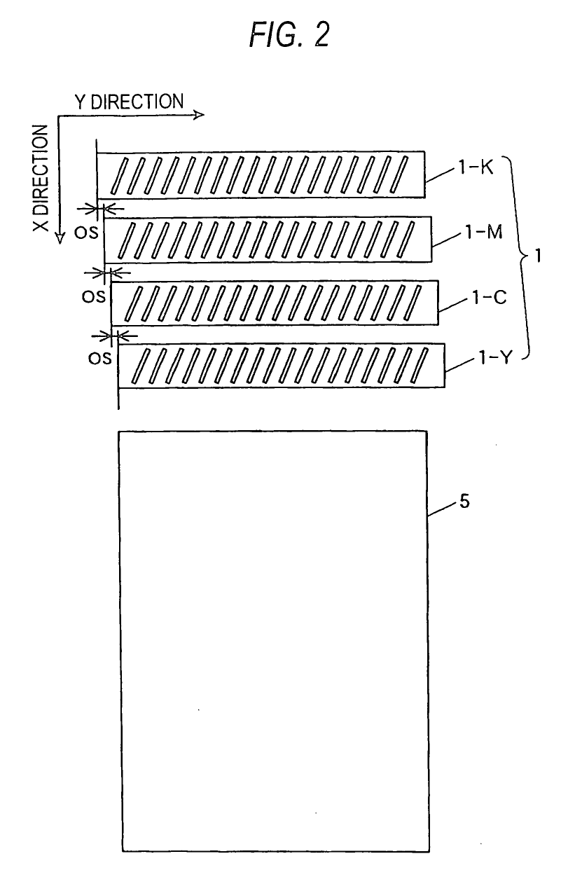

FIG. 2 shows that a line head 1-Y for yellow, a line head 1-C for cyan, a line head 1-M for magenta, and a line head 1-K for black, each of which is formed to extend in the Y direction, are placed by being offset with a width OS in a direction (Y direction) perpendicular to a relative transportation direction (X direction) of the recording medium 5 for printing.

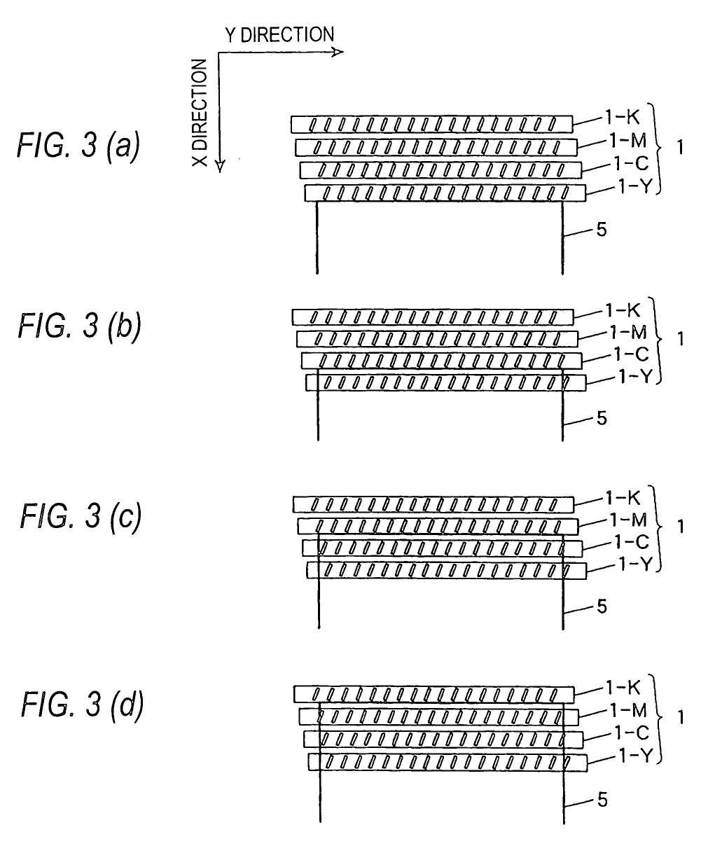

Referring to FIGS. 3(a) to 3(d), FIG. 3(a) shows a state where the recording medium 5 has reached the position at the end face of the line head 1-Y for yellow; FIG. 3(b) shows a state where the recording medium 5 has reached the position at the end face of the line head1-C for cyan; FIG. 3(c) shows a state where the recording medium 5 has reached the position at the end face of the line head1-M for magenta; and FIG. 3(d) shows a state where the recording medium 5 has reached the position at the end face of the line head 1-K for black.

FIG. 6 is a schematic view showing a line head for use in the CIJP formed by providing a plurality of individual heads in the Y direction. As shown in the drawing, a line head 1 comprises a plurality of individual heads 2, herein 18 of them, arranged in the Y direction.

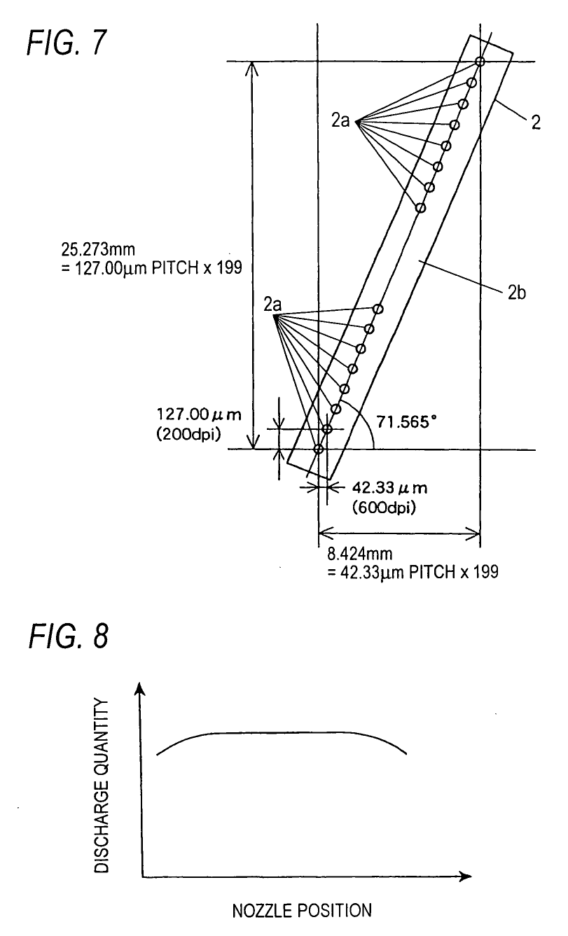

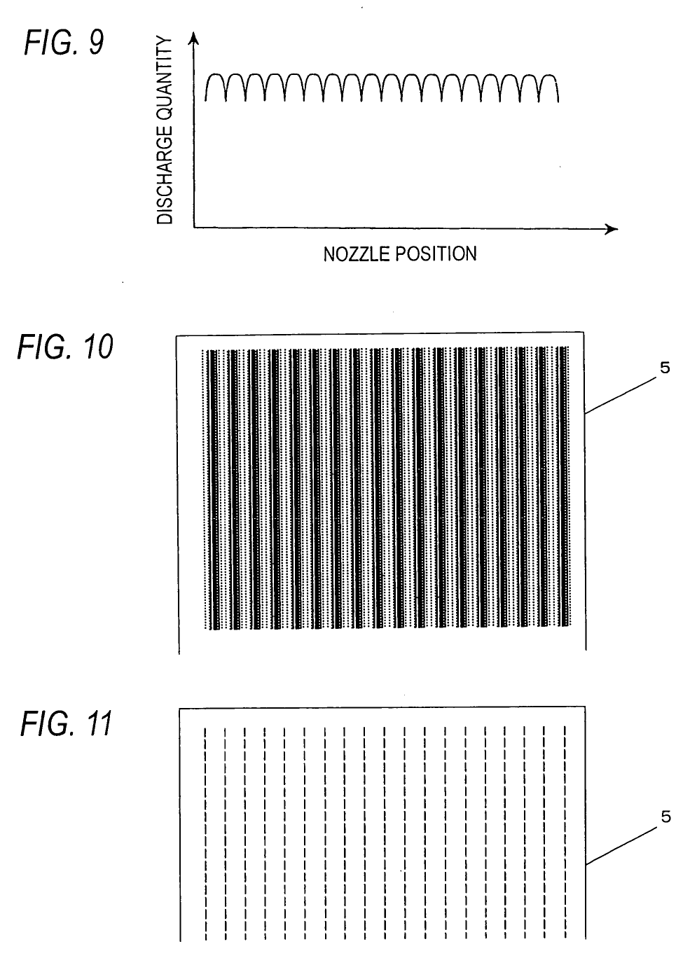

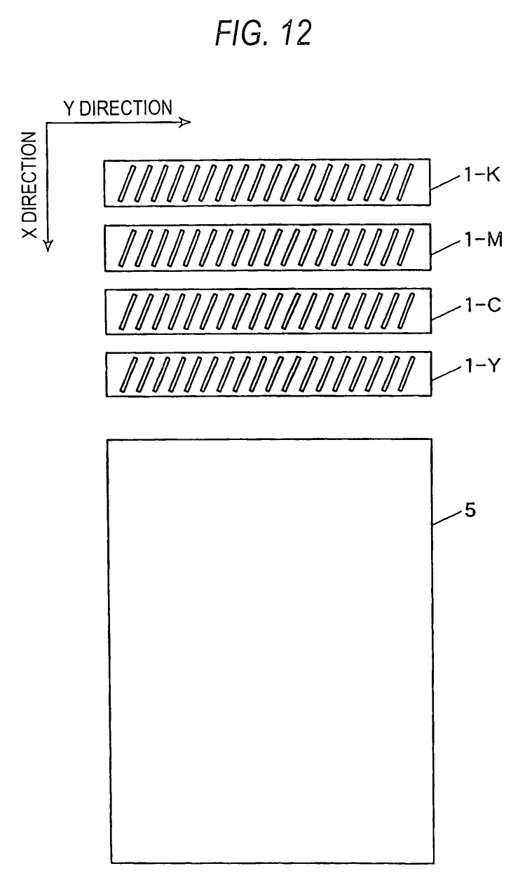

FIG. 7 is a schematic view of one individual head in the line head of FIG. 6. The individual head 2 includes 200 nozzles 2a on a pitch of 133.87 μm, which are placed obliquely with respect to the Y direction at an angle of 71.565 degrees. This provides resolution in the X direction on a pitch of 127.00 μm (200 dpi) and resolution in the Y direction on a pitch of 42.33 μm (600 dpi) with 3600 nozzles in total. The nozzles 2a are located on a nozzle surface 2b of the head 2.

A recording operation by the recording apparatus configured as shown in the block diagram of FIG. 1 will now be described in outline with reference to the schematic views of FIG. 2 and FIG. 3.

Referring to FIG. 1, upon receipt of a command for a recording operation from the control apparatus 11, such as an external PC, via the interface portion 12, the recording apparatus initially stores the received image data into the memory 13, and performs necessary processing, such as image processing and sorting of the data according to the head nozzle positions, while initializing the head control portion 15 and the motor control portion 16, all by means of the CPU 14.

When the initialization is completed by removing the capping used to prevent the ink at the nozzle head surface 2b and/or in the nozzle 2a from drying, cleaning the nozzle head surface, setting a reference voltage of an amplifier supplying a head driving waveform, refreshing ink in the vicinity of the nozzle ports through a forced discharge of ink droplets or meniscus vibrations, setting a reference original point and a control parameter of a recording medium transportation mechanism, moving the recording medium transportation mechanism to the printing start position, etc., the LF motor 19 is driven by the motor control portion 16 to start the transportation of the recording medium 5. In this instance, the relative positional relation between the line heads 1 and the recording medium 5 is as the one shown in FIG. 2.

The recording medium 5 is transported forward and when it reaches the printing start position for yellow shown in FIG. 3(a), the head control portion 15 supplies the line head for yellow 1-Y with recording data for yellow, whereupon printing in yellow on the recording medium 5 is started. In this instance, the line head for cyan 1-C, the line head for magenta 1-M, and the line head for black 1-K are supplied with zero data (data that is not recorded).

The recording medium 5 is then transported further and when it reaches the printing start position for cyan shown in FIG. 3(b), the head control portion 15 supplies the line head for cyan 1-C with recording data for cyan, whereupon printing in cyan on the recording medium 5 is also started. In this instance, the line head for magenta 1-M and the line head for black 1-K are supplied with zero data (data that is not recorded).

The recording medium 5 is then transported further and when it reaches the printing start position for magenta shown in FIG. 3(c), the head control portion 15 supplies the line head for magenta 1-M with recording data for magenta, whereupon printing in magenta on the recording medium 5 is also started. In this instance, the line head for black 1-K is supplied with zero data (data that is need not recorded).

The recording medium 5 is then transported further and when it reaches the printing start position for black shown in FIG. 3(d), the head control portion 15 supplies the line head for black 1-K with recording data for black, whereupon printing in black on the recording medium 5 is also started.

The transportation of the recording medium 5 by the motor control portion 16 and the recording operation by the head control portion 15 are repeated thereafter, and the recording on a single sheet of the recording medium 5 is completed in the same order when the recording started, that is, in order of yellow, cyan, magenta, and black.

When recording of a necessary number of sheets specified by the external control apparatus 11 is completed, the nozzle head surface is cleaned, the head is capped to prevent drying, the recording medium transportation mechanism is moved to the stand-by position, etc., and the recording apparatus is thereby returned to the original stand-by state.

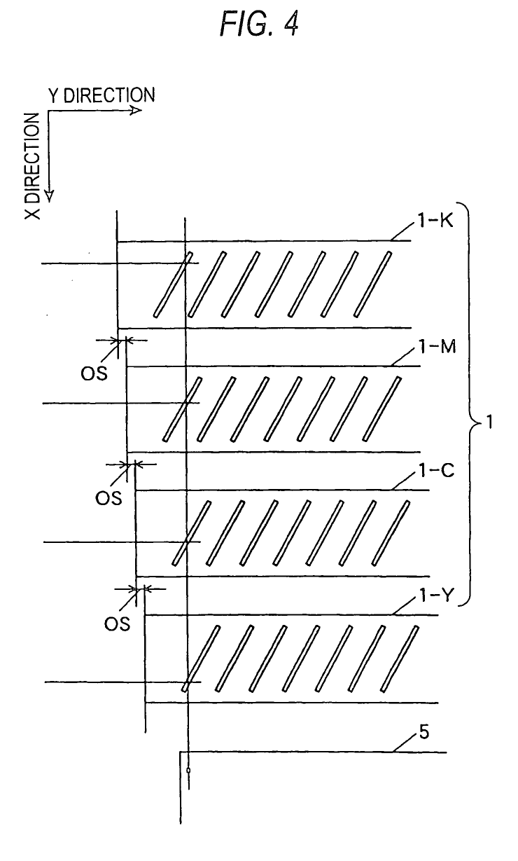

The above description described the recording data in the X direction alone, and the recording data in the Y direction will now be described with reference to FIG. 4. FIG. 4 is a view showing an enlarged portion of FIG. 2 to provide better understanding of an offset situation of the line heads in the Y direction.

In a case where a character “•” is to be printed in a corner of the recording medium 5 using the respective line heads, then it is understood that the position of the nozzle used to record this “•” is shifted not only in the Y direction, but also in the X direction in the line heads for respective colors. Because each line head is offset in the Y direction, the nozzle that is used to record “•” is naturally shifted in the Y direction; moreover, it should be noted that, because the individual heads 2 forming each line head are attached obliquely, the nozzle is shifted also in the X direction. For this reason, a correction is necessary in the processing by which image data read out from the memory 13 is supplied to the heads after the data is sorted according to the positions of the head nozzles and the order of data transfer to the heads.

This correction does not complicate the processing performed with the use of a conventional technique, that is, a technique for correcting the positions of a plurality of line heads to the extent that the line heads can be deemed as being placed in equivalently the same positional relation. A mere difference is that whether a plurality of line heads are aligned in the same positional relation or are offset, and zero data that is not printed is appended to an offset image region.

In other words, according to this embodiment, by offsetting the line heads, it is possible to prevent deterioration in the image quality by dispersing irregularities of the printing-related characteristic of the line heads color by color and thereby making density-varying streaks, black streaks, and white streaks less noticeable, while preventing the processing from becoming complicated.

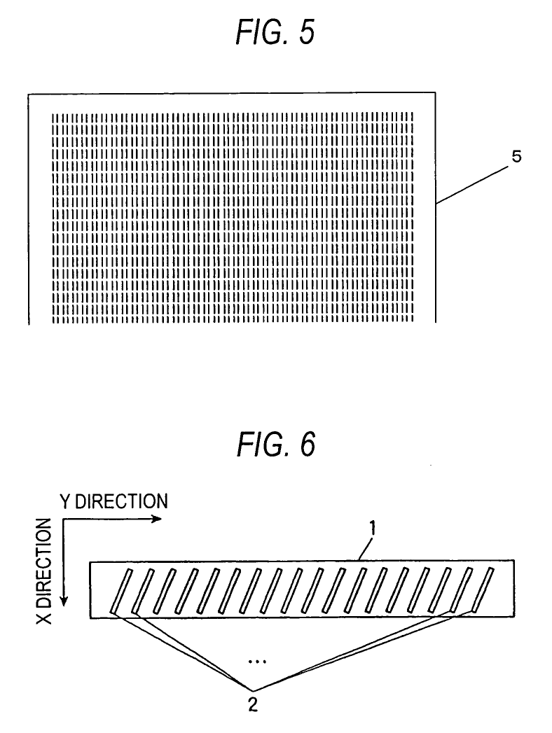

FIG. 5 shows appearances of a printing result on a recording medium when the line heads are offset as has been described above.

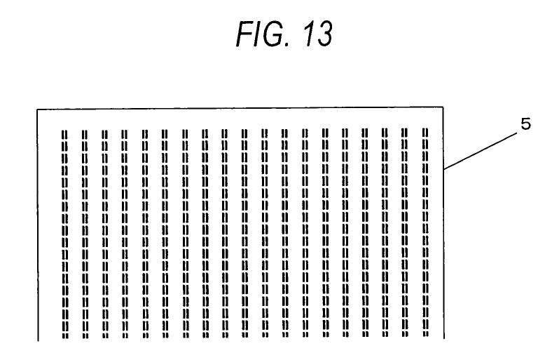

Compared with FIG. 13 showing appearances of a printing result on a recording medium when the line heads are not offset, it is understood that the number of broken lines representing the defects, such as black streaks, white streaks, density-varying streaks, is the same; however, they are dispersed uniformly. The defects, such as black streaks, white streaks, density-varying streaks, are enhanced more when they are concentrated, and thereby become more noticeable. This means, conversely, that the defects can be improved markedly when they are dispersed. In other words, when an image is printed on a recording medium by offsetting the line heads, the defects are dispersed as shown in FIG. 5, and the image quality can be thereby improved significantly.

Generally, a white streak in an image is especially noticeable, and deteriorates the image quality greatly. However, even when the line heads produce white streaks, in an image printed on a recording medium by offsetting the line heads, white streaks of a color are covered with another color, and the white steaks can be eliminated. Although differences in the density of the color may remain, it remains as a fine line, and therefore, is not as noticeable as white streaks. Hence, by eliminating the white streaks, significant improving effects can be achieved.

In this embodiment, an explanation was given to a configuration in which the line heads for all the colors are offset. However, satisfactory preventing effects for deterioration in the image quality can be expected by providing an offset to the line heads for only particular colors having considerable visual influences, such as cyan, magenta, and black. In short, a desired effect can be achieved by providing an offset to at least a few of the line heads.

Further, in this embodiment, an explanation was given to a case where the width OS is given as an offset size between the line heads. However, it is preferable to set the offset size to be almost equal to a value found by dividing a print width of the individual heads forming the line head by the number of colors, because in this case the defects, such as black streaks, white streaks, density-varying streaks, can be dispersed uniformly. To be more specific, when 4-color printing is performed using individual heads having 200 nozzles and resolution in the Y direction on a pitch of 42.33 μm (600 dpi), the offset is given as 42.33 μm×200/4=2116.5 μm. This equals to 50 dots in a 600-dpi image, and the offset is naturally on the lattice of 600 dpi. Hence, the image will not be disturbed, and the defects can be dispersed uniformly across the broadest region. Also, the recording apparatus was explained using an ink jet printer of a piezoelectric method as an example. It goes without saying that the same applies to an apparatus of any other method, for example, a thermal method.

In this specification, “set the offset size to be almost equal to a value found by dividing a print width of the individual heads by the number of colors” means to set the offset size to a value in the vicinity of the value found by dividing the print width of the individual heads by the number of colors, and the value also should be an integral multiple of resolution of the nozzle in the Y direction.

Further, this embodiment explained a case of 4-color printing. However, the invention is applicable to multi-color printing (at least two colors), and is effective for printing in any other number of colors, for example, 3-, 6-, or 7-color printing.

In this embodiment, the recording apparatus performs recording by scanning recording medium 5, that is, by transporting the recording medium 5 in the main scanning direction, but the recording apparatus may perform recording by scanning the line heads 1 instead.

Further, in this embodiment, an explanation was given to a configuration in which the line head comprises a plurality of individual heads. However, the invention is effective when the line head comprises a single head. For example, in the case of a line head with a width of 216 mm, it is possible to achieve a satisfactory improving effect also in a visual manner by setting the offset size to a range from 1 mm to 6 mm approximately.

Also, in this embodiment, an explanation was given to a case where the resolution in the X direction is on a pitch of 127.00 μm (200 dpi) and the resolution in the Y direction is on a pitch of 42.33 μm (600 dpi). However, the invention is not limited to the resolutions specified above.

As has been described, according to the invention, even when the line heads for respective colors produce defects on an image, such as black streaks, white streaks, and density-varying streaks, these defects can be reduced by outputting the respective colors to be super imposed. It is thus possible to achieve advantages that the print quality can be ensured without the need to improve an accuracy of components or add complicated processing.

What is claimed is:

1. A recording apparatus, comprising:
a first line head for injecting ink of a first color;
a second line head for injecting ink of a second color; and
relative movement means for moving a recording medium relative to said first and second line heads,
wherein said first line head is placed by being offset with respect to said second line head in a Y direction perpendicular to an X direction which is a relative transportation direction of said recording medium.

2. The recording apparatus according to claim 1, wherein each of said first and second line heads is formed by providing, in the Y direction, a plurality of individual heads, each of which is provided with a plurality of discharge ports.

3. The recording apparatus according to claim 1, further comprising a third line head for injecting ink of a third color,
wherein the third line head is placed by being offset with respect to both the first and second line heads in the Y direction.

4. The recording apparatus according to claim 1, further comprising a third line head for injecting ink of a third color,
wherein the third line head placed by being offset with respect to the second line heads in the Y direction, but not being offset with respect to the first line head in the Y direction.

5. The recording apparatus according to claim 2, wherein an offset size is set to be almost equal to a value found by dividing a print width of said individual heads by the number of colors.

6. The recording apparatus according to claim 3, wherein an offset size is set to be almost equal to a value found by dividing a print width of said individual heads by the number of colors.

7. The recording apparatus according to claim 4, wherein an offset size is set to be almost equal to a value found by dividing a print width of said individual heads by the number of colors.

8. A recording apparatus, comprising:
a plurality of line heads from which inks of first through N-th (N≧3) colors are discharged, respectively; and
relative movement means for moving a recording medium relative to said line heads,
wherein at least a part of said line heads are placed by being offset in a Y direction perpendicular to an X direction which is a relative transportation direction of said recording medium.
